(19) United States
(12) Patent Application Publication
(10) Pub. No.: US 2026/0269999 A1
(43) Pub. Date: Sep. 10, 2026

(54) REAL-TIME DELAY FEEDBACK FOR TRIGGERED UPLINK ACCESS

(71) Applicant: Cisco Technology, Inc., San Jose, CA (US)

(72) Inventors: Binita GUPTA, San Diego, CA (US); Brian D. HART, Sunnyvale, CA (US); Malcolm M. SMITH, Richardson, TX (US)

(21) Appl. No.: 19/556,688

(22) Filed: Mar. 4, 2026

Related U.S. Application Data
(60) Provisional application No. 63/766,942, filed on Mar. 4, 2025.
(60) Provisional application No. 63/796,335, filed on Apr. 28, 2025.

(51) Int. Cl. H04L 5/00; H04L 69/322

(52) U.S. Cl. CPC H04L 5/0044; H04L 69/322

(57) ABSTRACT

The present disclosure provides a method for providing real-time delay feedback for triggered uplink (UL) access, including buffering, by a client device, one or more uplink data units for transmission in a first transmit (Tx) queue, determining, by the client device, for each respective buffered uplink data unit of the one or more buffered uplink data units, a respective expiry deadline (ED) based on a respective delay bound associated with the respective buffered uplink data unit, and transmitting, by the client device, delay feedback information to an access point (AP), wherein the delay feedback information is determined based on the respective EDs of the one or more buffered uplink data units.

### CROSS-REFERENCE TO RELATED APPLICATIONS

This application claims benefit of co-pending U.S. provisional patent application Ser. No. 63/766,942 filed Mar. 4, 2025 and co-pending U.S. provisional patent application Ser. No. 63/796,335 filed Apr. 28, 2025. The aforementioned related patent applications are herein incorporated by reference in their entirety.

### TECHNICAL FIELD

Embodiments presented in this disclosure generally relate to wireless communication. More specifically, embodiments disclosed herein relate to determining and reporting real-time delay feedback for triggered uplink (UL) access to support adaptive UL scheduling.

### BACKGROUND

Stream classification service (SCS) in combination with quality-of-service (QoS) characteristics (QC) element can be used by stations (STAs) to provide quality-of-service (QoS) requirements for low-latency applications to an access point (AP). The QoS characteristics element provides traffic characteristics and requirements for a QoS/low-latency flow and is used by the AP to guide uplink (UL) access scheduling to meet UL QoS requirements for the flow. The scheduling mode can reduce or eliminate the need for buffer status reports (BSRs). However, instantaneous conditions at a client device, such as excess accrued delay in UL transmit (Tx) queue, may not be visible to the access point (AP) and therefore may not be considered when scheduling access resources for triggered UL operation.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example of a triggered uplink (UL) transmission in a wireless network, according to some embodiments of the present disclosure.

FIG. 2 depicts an example relationship between media access control (MAC) service data units (MSDUs) and MAC protocol data units (MPDUs), according to some embodiments of the present disclosure.

FIGS. 3A and 3B depict example scheduling behaviors performed by an access point (AP) in response to real-time delay feedback received from a station (STA) during triggered uplink (UL) transmission, according to some embodiments of the present disclosure.

FIGS. 4A-4D depict example formats of an Expiry Time Control field, according to some embodiments of the present disclosure.

FIGS. 5A and 5B depict example formats of an Enhanced Buffer Status Report (EBSR) Control field, according to some embodiments of the present disclosure.

FIGS. 6A and 6B depict example formats of a Feedback Per AID TID Info field, according to some embodiments of the present disclosure.

FIG. 7 depicts an example method for determining and reporting real-time delay feedback, according to some embodiments of the present disclosure.

FIG. 8 depicts an example method for adjusting triggered UL scheduling based on real-time delay feedback reporting, according to some embodiments of the present disclosure.

FIG. 9 is a block diagram depicting a delay feedback reporting method, according to some embodiments of the present disclosure.

FIG. 10 depicts an example STA MLD configured to perform various aspects of the present disclosure, according to some embodiments of the present disclosure.

FIG. 11 depicts an example AP MLD 1100 configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including buffering, by a client device, one or more uplink data units for transmission in a first transmit (Tx) queue, determining, by the client device, for each of the buffered uplink data units, an expiry deadline (ED) based on a delay bound associated with the respective buffered uplink data unit, and transmitting, by the client device, delay feedback information to an access point (AP), where the delay feedback information is determined based on the EDs of the one or more buffered uplink data units.

Other embodiments in this disclosure provide a computer program product comprising one or more computer-readable storage media collectively containing computer-readable program code that, when executed by operation of one or more computer processors, performs operations in accordance with one or more of the above methods, and a system of a network device comprising one or more computer processors, and one or more memories collectively containing one or more programs, which, when executed by the one or more computer processors, perform operations in accordance with one or more of the above methods.

### EXAMPLE EMBODIMENTS

In IEEE 802.11 wireless systems, the stream classification service (SCS) in combination with quality-of-service (QoS) characteristics (QC) element allows client devices or stations (STAs) to convey QoS characteristics associated with low-latency applications/flows. These characteristics may be used by an access point (AP) to guide triggered uplink (UL) access scheduling in order to satisfy UL latency and service interval requirements. Operations under SCS-based triggered UL scheduling can reduce or eliminate reliance on buffer status reports (BSRs) from the client to determine the amount of traffic queued in the UL transmit queues at the STA for triggered UL scheduling, which therefore reduces overhead and improves overall network efficiency for serving low-latency traffic flows.

However, when BSR polls and BSR exchanges are reduced or suppressed during SCS-based triggered UL operation, the AP may lack visibility into instantaneous conditions at a STA. More specifically, the AP may not have information indicating the current transmit queue state, accrued delay, or expiration deadlines associated with queued uplink data units. As a result, triggered UL scheduling decisions (e.g., those made in the short term), such as those associated with a next transmit opportunity (TXOP), may not consider delay urgency at the STA, and the system may fail to meet UL delay bound requirements for low-latency SCS streams under certain conditions.

One possible approach for addressing excess delays at a STA is for the STA to request a new or modified SCS configuration by revising QoS characteristics, for example, by reducing a maximum service interval. Such requests are typically processed by host-level or network-level processes and may not be fast enough (e.g., it may take multiple service intervals to complete). During this time, delay bounds associated with latency-sensitive applications may already be exceeded, leading to degradation in application performance. Accordingly, this approach does not provide a timely mechanism for responding to real-time and changing queue conditions at the STA.

Embodiments of the present disclosure provide methods, systems, and apparatuses that enable a client device or STA to provide real-time delay feedback to an AP for use in triggered UL scheduling decisions. As an SCS session progresses, and when a delay bound associated with an SCS flow is nearing expiration or has been exceeded, the STA reports delay feedback information to the AP, such as on a per-traffic identifier (TID) or per-access category (AC) basis or even per SCS stream basis. The delay feedback information reflects delay urgency associated with UL data units remaining in the STA's transmit (Tx) queue and is reported either in-band or out-of-band using one or more media access control (MAC)-layer signaling mechanisms. Based on the received delay feedback information, the AP adapts triggered UL scheduling for the STA.

In one embodiment, the STA determines expiry deadlines (EDs) for buffered UL data units and generates a relative delay value. As used herein, the relative delay value represents a time difference between a queue expiry deadline and a current time reference. The queue expiry deadline (ED) may be selected based on an earliest expiry deadline (ED) among buffered UL data units or based on an expiry deadline (ED) of a head-of-line (HoL) data unit in the transmit (Tx) queue (or STA can select other criteria to determine the queue expiry deadline). The relative delay value may indicate remaining time until expiry or excess delay accrued beyond expiry and provides the AP with a direct indication of delay urgency.

In another embodiment, a station (STA) is configured to determine a relative delay value based on a queue expiry deadline (ED) associated with a transmit queue. However, rather than reporting an exact delay value, the STA may select the relative delay value from a lookup table of a predefined set of delay values or delay value ranges. The relative delay value may be determined based on a time difference between the queue expiry deadline of the transmit queue and a current time reference, such as a Timing Synchronization Function (TSF) time. The queue expiry deadline (ED) may be defined as described above. The STA may select, from the predefined set of delay value ranges, a delay range corresponding to or closest to the determined time difference.

In one embodiment, the predefined set of delay value ranges may include: (i) delay <5 milliseconds (msec); (ii) delay between 5-10 msec; (iii) delay between 10-20 msec; (iv) delay between 20-30 msec; (v) delay between 30-50 msec; (vi) delay between 50-100 msec; and (vii) delay >100 msec. For example, if the time difference between the queue expiry deadline and the current time reference is 15 msec, the STA may report the relative delay value corresponding to the delay range of 10-20 msec. Accordingly, the relative delay value reported by the STA may correspond to one of a plurality of predefined delay buckets for real-time delay reporting. The reported relative delay value may indicate an estimate of remaining time until expiry of the transmit queue or, in some cases, an excess delay accrued beyond expiry. In this manner, the reported relative delay value provides an access point (AP) with a direct indication of delay urgency.

In another embodiment, the STA reports a queue ED itself as a time offset value (e.g., a timing synchronization function (TSF)-based timestamp or based on another time reference). The queue ED may be determined based on either an earliest ED among buffered uplink data units or an ED of a HOL UL data unit. By comparing the reported queue ED against a current time reference, the AP determines delay urgency and adjusts UL scheduling accordingly.

Upon receiving delay feedback information indicating the real-time delay feedback, the AP adapts triggered UL scheduling for the STA. In some embodiments, the AP may allocate additional UL resources to the STA within a current service interval for that STA. In other embodiments, the AP may adjust UL resource allocation in a subsequent service interval for that STA. These scheduling responses may be applied independently of how the delay feedback information is computed or reported.

The delay feedback information may be transmitted using in-band or out-of-band signaling. In some embodiments, the delay feedback information may be carried in a High-Efficiency (HE) A-Control field of a QoS data frame, including in media access control (MAC) protocol data units (MPDUs) aggregated in an A-MPDU. The delay feedback information may be carried in an HE A-Control field in a QoS Null frame, besides a QoS data frame. In other embodiments, the delay feedback information may be transmitted using an extended enhanced buffer status report (EBSR) control field carried within a HE A-Control field of a data frame. In other embodiments, delay feedback information is transmitted using control frames, including initial control frames (ICF) (e.g., buffer status report poll (BSRP) trigger frames or BSRP non-trigger-based (NTB) trigger frames) or initial control response (ICR) frames (e.g., multi-STA block acknowledgement (BA) frames). In some other embodiments, the delay feedback information may even be reported to the AP in a management frame or action frame, such as an Ultra High Reliability (UHR) Link Reconfiguration Notify frame (e.g., with a new Type value indicating reporting of delay feedback information).

The disclosed embodiments enable a STA to provide real-time delay feedback based on expiry deadlines of UL data units queued in the Tx queue, on a per-TID, per-AC basis, or per-SCS stream basis. By transmitting delay urgency associated with queued UL traffic, the delay feedback information allows an AP to make timely triggered UL scheduling decisions that better adapt to instantaneous queue conditions and expiry deadlines of data units at the STA. Such feedback is useful for meeting delay-bound requirements of latency-sensitive applications, such as real-time voice and video communications as well as augmented reality (AR), virtual reality (VR), and extended reality (XR) applications, particularly in congested wireless environments.

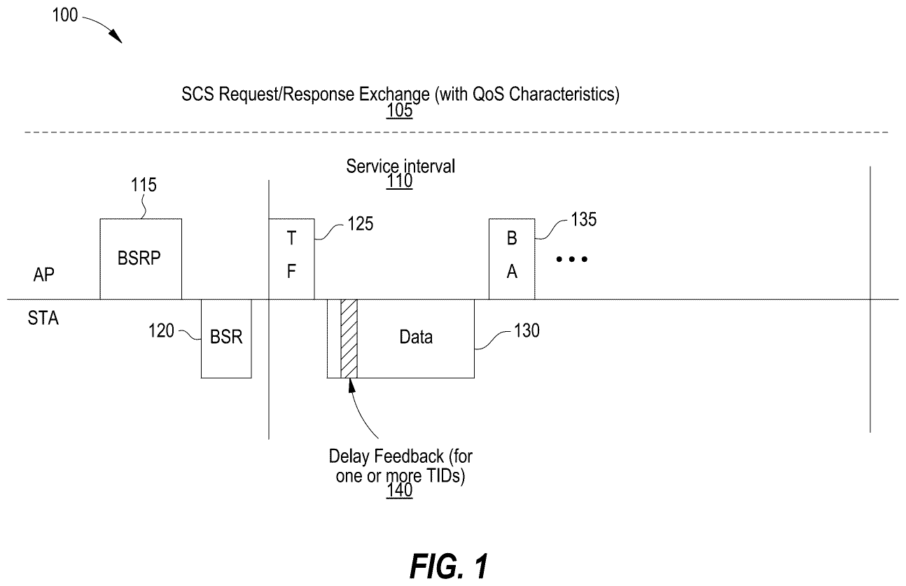

FIG. 1 depicts an example 100 of a triggered uplink (UL) transmission in a wireless network. As shown, a station (STA) or client device establishes a stream classification service (SCS) stream using SCS Request/Response with QoS characteristics exchange 105 with an associated access point (AP). The SCS request with QC communicates QoS traffic characteristics for low-latency streams, such as service interval (SI) (e.g., minimum or maximum SI) and delay bound information. The exchanged QoS characteristics are then used by the AP to guide triggered UL scheduling during one or more service intervals 110 (e.g., during SI based on the QoS characteristics of the SCS stream or a transmit opportunity (TXOP) acquired by the AP).

Once an SCS stream is established, triggered uplink access may be scheduled without requiring frequent buffer status report (BSR) exchanges. As illustrated, a buffer status report poll (BSRP) 115 (sent by an AP) and a corresponding BSR 120 (sent by the STA) may be exchanged for an AP to determine the amount of buffered traffic at the STA prior to the AP triggering the STA in UL, but such exchanges may be reduced or suppressed during SCS-based operation. Although the SCS Request/Response with QC exchange and optional BSR signaling provide information regarding traffic characteristics and buffer occupancy, neither mechanism conveys information indicating delay accrued by UL data units queued in a transmit (Tx) queue of the STA or proximity (or imminence) to expiration of associated delay bounds.

Embodiments of the present disclosure provide mechanisms by which real-time delay status is transmitted by the STA to the AP to convey such delay urgency information associated with one or more traffic identifiers (TIDs) (or access categories (ACs) or SCS streams identified by SCS IDs). As depicted in FIG. 1, during a triggered UL service interval (e.g., during SI determined by the AP based on the QoS characteristics of the SCS stream or a TXOP), the AP transmits a trigger frame (TF) 125 to initiate triggered UL transmission, followed by UL data 130 transmitted by the STA and a block acknowledgement (BA) 135 transmitted by the AP. In the illustrated example, delay feedback information 140 is included in-band with the UL data 130. This allows the AP to receive real-time delay urgency information contemporaneously with the UL transmission and to adapt subsequent triggered UL scheduling decisions accordingly.

The delay feedback information 140 may include delay urgency associated with uplink data units remaining in the STA transmit queues and may be determined based on expiry deadlines of such queued data units. A STA may have one or more transmit queues (e.g., one transmit queue per TID or per AC), and the reported delay feedback information 140 may provide delay urgency associated with uplink data units for one or more such transmit queues. In some embodiments, the delay feedback information includes a relative delay value determined by comparing a queue expiry deadline (e.g., based on an earliest-expiring UL data unit or a HOL UL data unit) with a time reference of a reference link (e.g., a current timing synchronization function (TSF) value). In some embodiments, the delay feedback information reported is based on a relative delay value selected from a predefined set of delay value ranges (e.g., <5 msec, 10-20 msec, 20-30 msec, 30-50 msec, 50-100 msec, or >100 msec).

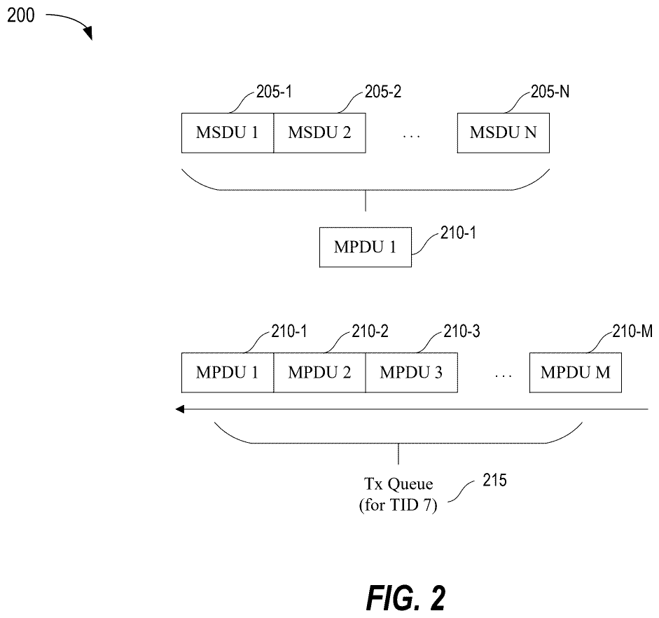

In other embodiments, the delay feedback information includes an expiry deadline expressed using a time reference (e.g., a TSF value). More details about the determination and signaling of the delay feedback information are discussed below with reference to FIGS. 2, 4A-4D, 5A-5B, and 6A-6B.

FIG. 2 depicts an example relationship 200 between media access control (MAC) service data units (MSDUs) and MAC protocol data units (MPDUs), and the determination of expiry deadlines for UL data buffered in a Tx queue of a STA.

As illustrated, a plurality of MSDUs, including MSDU 1 (205-1), MSDU 2 (205-2), and up to MSDU N (205-N), are encapsulated within an MPDU, such as MPDU 1 (210-1). In some embodiments, multiple MSDUs 205 may be aggregated as an A-MSDU and carried within an MPDU. As further depicted, multiple MPDUs 210 are buffered in a Tx queue 215 at the STA, including MPDU 1 (210-1), MPDU 2 (210-2), MPDU 3 (210-3), and up to MPDU M (210-M). In the illustrated example, MPDU 1 is located at the head of the TX queue 215, ahead of subsequent MPDUs, including MPDU 2 through MPDU M.

For each MSDU, an expiry time is determined based on a delay bound associated with the traffic to which the MSDU belongs (e.g., the delay bound of the corresponding SCS stream). In one embodiment, the expiry time of an MSDU is calculated as a TSF time corresponding to the arrival of the MSDU at a MAC service access point (MAC-SAP) plus a delay bound. An example equation for calculating the expiry time of an MSDU is provided below.

$$Expiry Time ( MSDU ) = {TSF}_{arrival} ( MSDU ) + Delay Bound$$

As used herein, the TSF time selected for the MSDU arrival time, TSFₐᵣᵣᵢᵥₐₗ (MSDU), is based on a reference link selected by the STA, which may be indicated to the AP when reporting delay feedback. The Delay Bound is obtained from QoS characteristics (QC) parameters associated with the SCS stream to which the MSDU belongs. In some embodiments, some other time reference can be used for expiry time calculation in place of the TSF time.

An expiry deadline (ED) is determined for each MPDU 210 based on the MSDUs 205 carried in the MPDU 210. In one embodiment, the ED of an MPDU is set equal to the earliest expiry time among all MSDUs encapsulated in the MPDU, including MSDUs aggregated within an A-MSDU payload. In the illustrated example 200, an ED of MPDU 1 (210-1) is determined based on the expiry time of each MSDU encapsulated within MPDU 1, including MSDU 1 (205-1) through MSDU N (205-N), and is set to the earliest expiry time among those MSDUs. Once determined, the ED of an MPDU remains fixed as the MPDU progresses through the Tx queue and when the MPDU is transmitted.

The delay feedback provided to the AP may be based on ED of MPDUs 210 remaining in the Tx queue 215 and may be reported on a per-traffic identifier (TID) or per-access category (AC) basis (or even per-SCS ID basis) to report delay feedback for multiple transmit queues at the STA. In one embodiment, delay feedback for a given TID is determined based on the earliest expiry deadline among all queued MPDUs associated with that TID in the transmit queue for that TID. An example equation for calculating the delay feedback for a specific TID is provided below.

$$Delay Feedback ( {TID}_{x} ) = \vert earlist ED of queued MPDUs in the {TID}_{x} queue - current TSF of reference link \vert$$

As used herein, the TIDₓ represents any TID value, for example, TIDs 0-7, or TIDs 8-15 in future implementations.

In the illustrated example 200, the MPDUs 210 buffered in the Tx queue 215 are associated with a specific TID, such as TID 7, and MPDU 3 (210-3) has an earliest ED compared to other MPDUs in the Tx queue. Accordingly, the delay feedback for the Tx queue (for TID 7) is determined based on the ED of MPDU 3 minus the current TSF value. The illustrated association of MPDUs buffered in a Tx queue with a respective TID is provided for conceptual clarity. In some embodiments, Tx queues may be organized on a per-AC basis or per-SCS ID basis or using other mappings between traffic identifiers and queues, and then delay feedback information may be reported based on a per-AC or per-SCS ID basis.

In another embodiment, delay feedback for a given TID is determined based on an ED of a HoL MPDU in the Tx queue associated with that TID. For example, the delay feedback for TIDₓ may be represented as the difference between the ED of the Hol MPDU for TIDₓ and a current TSF value of a reference link, as shown below.

$$Delay Feedback ( {TID}_{x} ) = \vert earlist ED of HoL MPDU in the {TID}_{x} queue - current TSF of reference link \vert$$

In the illustrated example 200, although MPDU 3 (210-3) has an earlier deadline compared to other MPDUs 210 buffered in the Tx queue 215, MPDU 1 (210-1) is located at the head of the Tx queue and therefore corresponds to the HoL MPDU for the TID 7. Therefore, in this embodiment, the delay feedback for the Tx queue is determined based on the ED of MPDU 1 minus the current TSF value (instead of based on the earliest ED among all queued MPDUs).

Within the two embodiments discussed above, when an ED has already passed, the condition is indicated in the delay feedback, such as by setting an “expiry deadline in past” indication. In such configurations, the reported delay feedback represents excess delay accrued beyond the earliest ED. In some embodiments, an MPDU may be queued for slightly longer beyond the expiry time or ED in the transmit queue, such as an additional percentage (e.g., 10-20%) of the delay bound beyond the expiry deadline, and is still considered in the delay feedback reporting. After this additional time, the MPDU is removed from the Tx queue and is no longer considered in delay feedback reporting.

Within the various embodiments discussed herein, the STA may report delay feedback for all TIDs or for a subset of TIDs, such as higher-priority TIDs (e.g., TID 4-7). Selection of which TIDs to report may be based on the imminence of expiry deadlines across different TIDs, with TIDs having earlier EDs reported first. When delay feedback is reported for a dynamic set of TIDs, a TID bitmap may be included to identify the reported TIDs, and different TIDs may be reported in different MPDUs of an A-MPDU. When the set of reported TIDs is fixed, the identity of a TID may be inferred based on a predefined field location or reporting order. In one embodiment, an A-Control field in an MPDU reports delay feedback for the TID carried by that MPDU, and when multiple MPDUs are aggregated in an A-MPDU, each MPDU may report delay feedback for its corresponding TID.

In some embodiments, the delay feedback information is encoded using a compact representation to reduce signaling overhead when transmitted to the AP. For example, the STA may use a fixed number of bits per TID, such as three, four, five, six, or eight bits per TID (or a higher number of bits), and delay feedback may be reported for multiple TIDs within an A-Control field, such as for a set of higher-priority TIDs (e.g., TIDs 4-7), and/or for additional mapped TIDs mapped to ACs corresponding to higher-priority TIDs (or user priorities (UPs)).

In one embodiment, delay feedback values are encoded by selecting a value from a lookup table of predefined delay values represented in timing units (TUs) or milliseconds. Specifically, the STA determines a relative delay value based on a time difference between a queue expiry deadline (ED) and a current time reference (e.g., a TSF time). Instead of reporting the exact time difference, the STA may select the relative delay value from a predefined value or delay range corresponding to, or closest to, the determined time difference. For example, predefined delay ranges may include ranges: (i) delay <5 msec; (ii) delay between 5-10 msec; (iii) delay between 10-20 msec; (iv) delay between 20-30 msec; (v) delay between 30-50 msec; (vi) delay between 50-100 msec; and (vii) delay >100 msec. If the determined time difference is 15 msec, the STA may report a relative delay value corresponding to the 10-20 msec range. Accordingly, the reported relative delay value may correspond to one of a plurality of predefined delay buckets representing delay urgency. The reported relative delay value may indicate an estimate of the remaining time until expiry of the transmit queue or, in some cases, an excess delay that occurred beyond expiry. In this configuration, the STA provides the AP with a direct indication of delay urgency.

In another embodiment, delay feedback values are encoded using a flat representation up to a predetermined maximum delay value, with one or more reserved values indicating larger delays. In another embodiment, delay feedback values are encoded using a Delay mantissa field (e.g., a 2-bit field) and a Delay exponent field (e.g., a 2-bit field), where the delay feedback value is represented as a product of a mantissa and an exponent as shown below with Delay mantissa and Delay exponent fields. Any of these encoding approaches may be used individually or in combination, and a lookup-table-based encoding may be preferred in some implementations due to the finer granularity achievable with a limited number of bits.

$$Delay feedback = Delay mantissa \times {2}^{Delay exponent}$$

In some embodiments, the compact representation may further include an indication when an ED has already passed, such as by setting an “expiry deadline in past” indication. In such cases, the encoded delay feedback represents excess delay accrued beyond the expiry deadline.

In some embodiments, instead of reporting a relative delay value, the STA may report an ED for queued MPDUs. In one embodiment, the delay feedback for TIDₓ is set equal to the earliest ED (e.g., represented as a TSF value) among queued MPDUs in the transmit queue of that TID, as shown below.

$$Delay Feedback ( {TID}_{x} ) = earlist ED of queued MPDUs in the {TID}_{x} queue$$

In another embodiment, the delay feedback for TIDₓ is set equal to the ED of a HoL MPDU in the transmit queue of that TID, as shown below.

$$Delay Feedback ( {TID}_{x} ) = earlist ED of HoL MPDU in the {TID}_{x} queue$$

The ED is represented by a TSF time based on the TSF of the reference link. A reduced number of TSF bits may be reported, such as with a granularity of one time unit (TU) (where one TU is 1024 microseconds), and a predetermined number of TSF bits, such as TSF bits [15, 10] (6 TSF bits), are included in the delay feedback information. In some embodiments, a reporting mode indicator is included to identify a set of TIDs for which EDs are reported. For example, a first reporting mode (e.g., Mode=0) may correspond to reporting EDs for a first set of TIDs (e.g., TIDs 4 and 5 and an additional mapped TID, such as an additional mapped TID corresponding to background AC (or AC_BK) used for mapping video (VO) or voice (VI) traffic), and a second reporting mode (e.g., Mode=1) may correspond to reporting EDs for a different set of TIDs (e.g., TIDs 6 and 7 and an additional mapped TID (e.g., an additional mapped TID corresponding to best-effort AC (or AC_BE) used for mapping VO or VI traffic). When EDs are reported for three TIDs, the total number of bits used to convey the ED information may be on the order of approximately 19-20 bits, depending on the selected encoding.

In some embodiments, a larger granularity may be selected for ED to further reduce overhead. For example, when a granularity of two time units (TUs) is used, a smaller number of TSF bits, such as TSF bits [15, 11], may be reported. In embodiments where a TSF time from a reference link other than the current link is used, a link identifier (Link ID) corresponding to the reference link is included in the A-Control information to allow the AP to correctly interpret the reported ED. EDs for different TIDs may be reported in different MPDUs of an A-MPDU, and in some embodiments, an MPDU reports the ED for the TID carried by that MPDU, which is identified by the TID included in the QoS control field in the MAC header. The direct ED reporting mechanism may be preferred in some implementations (compared with the relative delay feedback reporting mechanism) because it avoids last-minute computation when populating the A-Control field.

In some embodiments, ED may be represented using any other timing reference, instead of the TSF time.

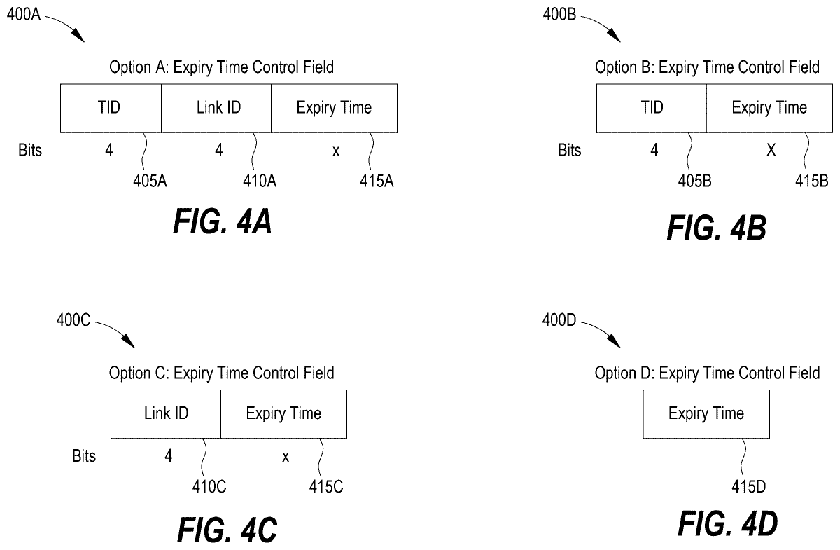

Further details regarding encoding mechanisms for relative delay feedback reporting and for direct ED reporting are discussed below with reference to FIGS. 4A-4D, 5A-5B, and 6A-6B.

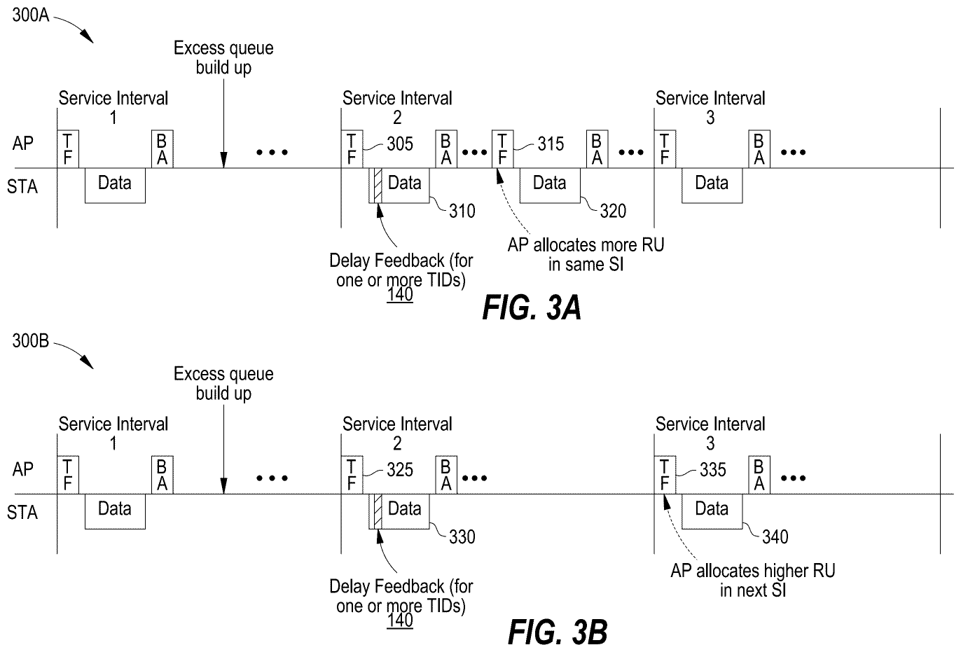

FIGS. 3A and 3B depict example scheduling behaviors performed by an AP in response to real-time delay feedback received from a STA for triggered UL transmission.

In the first scenario 300A, an excess buildup of queued UL data occurs at the STA during Service Interval 1, leading to increased delay for one or more UL data units. During Service Interval 2, the STA transmits UL data 310 in response to a TF 305 issued by the AP. As illustrated, the UL data 310 includes delay feedback information in-band for one or more TIDs (e.g., carried in an A-Control field). The delay feedback can also be provided for one or more ACs (or even one or more SCS IDs). Upon receiving the delay feedback information during Service Interval 2, the AP determines that delay urgency exists for the STA and adjusts triggered UL scheduling within the same service interval. To determine delay urgency for the STA, the AP may use the delay feedback information and the QoS characteristics received (in the QoS Characteristics element) for SCS streams as part of SCS setup. In the illustrated example 300A, the AP transmits an additional TF 315 that allocates additional UL resources, such as larger or additional resource units (RUs), to the STA. Following the allocation, additional UL data 320 is transmitted during Service Interval 2 to mitigate excess delay.

In the second scenario 300B, an excess buildup of queued UL data similarly occurs during Service Interval 1. During Service Interval 2, the STA transmits UL data 330 in response to a TF 325 issued by the AP. The UL data 330 includes delay feedback information in-band for one or more TIDs. The delay feedback can also be provided for one or more ACs (or even one or more SCS IDs). In this embodiment, instead of adjusting scheduling within the same service interval, the AP uses the received delay feedback information to adjust UL scheduling in a subsequent service interval. Similarly, to determine delay urgency for the STA, the AP may use the delay feedback information and the QoS characteristics received (in the QoS Characteristics element) for SCS streams as part of SCS setup. In this example, AP determines that more UL resources can be scheduled to the STA in a subsequent service interval to mitigate excess delay. As illustrated, during Service Interval 3, the AP transmits a TF 335 that allocates higher UL resources, such as larger or additional RUs, to the STA. The allocation enables UL data transmission 340 with increased capacity to address the previously reported delay urgency.

In both scenarios 300A and 300B, the delay feedback information provides the AP with real-time visibility into delay conditions associated with UL data remaining in the STA Tx queue. The real-time information allows the AP to adapt triggered UL scheduling either immediately (e.g., within the same service interval) or in a subsequent service interval. The illustrated scheduling behaviors are provided for conceptual clarity. In some embodiments, other scheduling adaptations for UL scheduling may be applied based on the received delay feedback information.

FIGS. 4A-4D depict example formats of an Expiry Time Control field (or Delay Feedback Control field or any other suitable field) that may be carried within an HE A-Control field of a QoS data frame to transmit ED information from a STA to an AP. Due to the limited size of a Control field within a High-Efficiency (HE) A-Control, one approach is to provide expiry time information for a single TID within a given Control field. In some embodiments, a new Control field, also referred to herein as an Expiry Time Control field, is defined to convey the ED information.

As used herein, the Expiry Time Control field transmits an expiry time associated with UL data units, such as MSDUs, A-MSDUs, MPDUs, or A-MPDUs, buffered at the STA. The expiry time may be conveyed in different forms. In some embodiments, the expiry time includes a relative delay value, such as a time difference between a queue expiry deadline and a reference time. The relative value may be selected from a predefined set of delay value ranges, such that the reported value corresponds to a delay bucket representing delay urgency. In other embodiments, the expiry time includes an expiry TSF time (or expiry time based on another time reference), which indicates the earliest expiry deadline for the indicated traffic. To reduce signaling overhead, the expiry TSF time may carry only a subset of bits of a TSF value, such as 5, 6, or 8 bits, as described above, corresponding to a portion of the TSF time based on the granularity of ED reporting.

FIG. 4A (Option A) illustrates an Expiry Time Control field format 400A that includes a TID field 405A, a Link ID field 410A, and an Expiry Time field 415A. In this format 400A, the TID field 405A identifies the TID to which the reported expiry information applies, and the Link ID field 410A identifies a reference link of which the TSF time is used as the reference. The Expiry Time field 415A may include either a relative delay value (e.g., a time difference between a queue ED and a reference time) or an expiry TSF time indicating an ED (e.g., based on an earliest-expiring or Hol UL data unit) for the transmit queue for the indicated TID. This format 400A may be used when the expiry information is referenced to a link other than the link on which the Control field is transmitted.

FIG. 4B (Option B) illustrates an Expiry Time Control field format 400B that includes a TID field 405B and an Expiry Time field 415B, but omits a Link ID field. The format 400B is used when the current link where the expiry information is being reported is used as the reference link for TSF time for the expiry time reporting, such that a separate Link ID does not need to be provided. The Expiry Time field 415B may include either a relative delay value generated from a queue ED or a real expiry TSF time, as described for the Option A above.

FIG. 4C (Option C) illustrates an Expiry Time Control field format 400C that includes a Link ID field 410C and an Expiry Time field 415C, but omits a TID field. In this format 400C, the Expiry Time field 415C applies to the TID that is already indicated in the QoS Control field (in the MAC header) of the MPDU (or A-MPDU) carrying the Expiry Time Control field. Because the applicable TID is indicated via the QoS Control field, a separate TID field within the Expiry Time Control field is not desired (or required). The Expiry Time field 415C may represent either a relative delay value or a real expiry TSF time, referenced to the TSF of the link identified by the Link ID field, as described for the Option A above.

FIG. 4D (Option D) illustrates an Expiry Time Control field format 400D that includes only an Expiry Time field 415D, omitting both the TID field and the Link ID field. In this format 400D, the Expiry Time field 415D applies to the TID indicated in the QoS Control field (in the MAC header) of the MPDU (or A-MPDU), and the current link where the expiry time information is being reported is used as the reference link for the TSF time for the expiry time reporting. The Expiry Time field 415D may include a relative delay value or a real expiry TSF time, as described for the Option A above. This format 400D may be used when both the applicable TID and the reference link can be determined using other means as described.

In the illustrated formats 400A-400D, the Expiry Time Control field enables efficient signaling of expiry-related delay information within the limitations of an A-Control field.

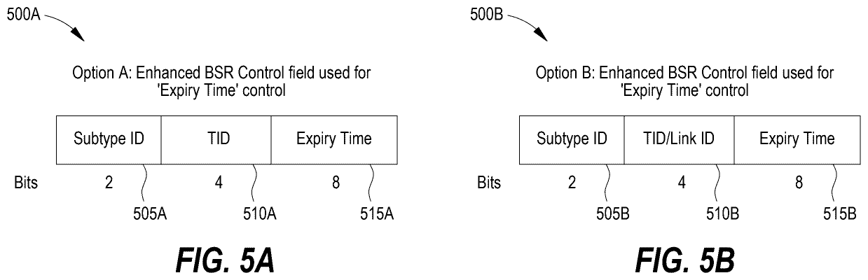

FIGS. 5A and 5B depict example formats for reporting expiry time information in an Enhanced Buffer Status Report (EBSR) Control field within an HE A-Control field of a data frame.

In IEEE 802.11bn, a new EBSR Control field is being defined for the HE A-Control field to support reporting of larger buffer status information compared to legacy BSR formats. The EBSR Control field is defined to include a reserved field (e.g., 2 bits), a TID field (e.g., 4 bits), and a queue size indicator (QSI) field (e.g., 8 bits). In conventional operation, the QSI field indicates buffer occupancy information for the identified traffic.

Within embodiments of the present disclosure, the EBSR Control field is reused and extended to convey expiry time information. More specifically, one or more bits of the reserved field are used to indicate a Control field subtype, referred to herein as an Expiry Time Control subtype. For example, one reserved bit may be set to a predetermined value to indicate the Expiry Time Control subtype, or a specific value of a multi-bit value may be used for this purpose. When the Expiry Time Control subtype is indicated, the QSI field is reused to indicate expiry time information, also referred to herein as an Expiry Time field. Other EBSR-based formats may also be used to convey expiry time information in the extended EBSR Control field.

FIG. 5A (Option A) illustrates an extended EBSR Control field format 500A, where the Control field includes a Subtype ID field 505A, a TID field 510A, and an Expiry Time field 515A. In this format, the Subtype ID field 505A comprises one or more reserved bits of the EBSR Control field and indicates that the Control field is of an Expiry Time Control subtype. The TID field 510A identifies the TID for which the expiry time is reported. The Expiry Time field 515A indicates expiry time information for the indicated TID, relative to the TSF time of the current link on which the data frame carrying the A-Control field is transmitted. The Expiry Time field 515A may include either a relative delay value, such as a time difference between a queue expiry deadline and a reference time, or a real expiry deadline, such as an expiry TSF time.

FIG. 5B (Option B) illustrates an extended EBSR Control field format 500B, where the Control field includes a Subtype ID field 505B, a TID/Link ID field 510B, and an Expiry Time field 515B. The Subtype ID field 505B indicates that the EBSR Control field is being used to transmit expiry time information. In this format, the TID associated with the expiry time is indicated by the TID field in a QoS Control field of the MPDU carrying the extended EBSR Control field, and the TID/Link ID field 510B identifies a reference link of which TSF time is used as the basis for interpreting the Expiry Time field 515C. The Expiry Time field 515C may include either a relative delay value derived from a queue ED or a real or absolute expiry TSF time.

In some embodiments, expiry time information is transmitted out-of-band, separate from data transmission, using one or more control frames. For example, expiry time information may be transmitted using an initial control frame (ICF), such as a BSRP Trigger frame or a BSRP NTB Trigger frame, or using an initial control response (ICR) frame, such as a multi-STA block acknowledgment (BA) frame. Out-of-band signaling may be used in addition to, or as an alternative to, in-band signaling within data frames.

In one embodiment, expiry time information is indicated in an ICF, such as a BSRP Trigger frame or a BSRP NTB Trigger frame. Expiry time information for one or more TIDs may be provided in a User Info field of the BSRP Trigger frame or a BSRP NTB Trigger frame. The expiry time information may be conveyed as a list of <TID, Expiry Time> pairs. A count field may be included to indicate a number of TIDs for which expiry time information is provided. In some embodiments, a TID bitmap is used together with one or more expiry time values, where a bit corresponding to a TID is set to indicate that expiry time information is provided for that TID. The expiry time information may include a relative delay value, such as a time difference between a queue ED and a reference time, or a delay value selected based on a lookup table of predefined delay value ranges, or an absolute expiry TSF time. In some embodiments, a Link ID is included when the expiry time is referenced based on a link other than the current link where the expiry time information is reported.

In another embodiment, expiry time information is indicated in an ICR frame, such as a multi-STA BA frame. In this configuration, a Feedback Per AID TID Info field may be used to report expiry time information. A new Expiry Time Feedback type (or delay feedback type) may be defined to indicate that the Feedback field includes expiry time (or delay feedback) reporting. In some embodiments, a new Per AID TID field format may be defined specifically for reporting expiry time information. The Expiry Time Feedback type may provide expiry time information for one or more TIDs for the STA.

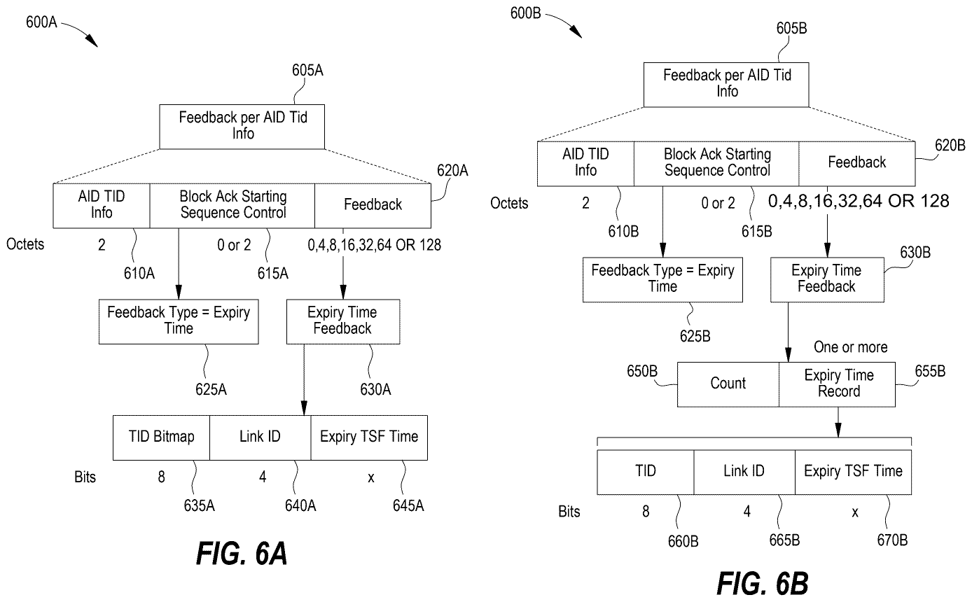

FIG. 6A illustrates an example format 600A for reporting expiry time information in an ICR using a TID bitmap-based approach.

As shown, a Feedback Per AID TID Info field 605A includes an AID TID Info field 610A, a Block Ack Starting Sequence Control field 615A, and a Feedback field 620A. The AID TID Info field 610A identifies the target for the Feedback Per AID TID Info. In the ICR sent by the STA, the field 610A may be set to an AID value (such as AID 2008 or another AID value) that indicates a group-addressed ICR or an AID value that indicates that the ICR is targeted for the AP. The Block Ack Starting Sequence Control field 615A provides block acknowledgement context. In this format 600A, the Block Ack Starting Sequence Control field 615A includes a Feedback Type field 625A, which is used to indicate that the corresponding feedback information relates to expiry time reporting. In one embodiment, the Feedback Type field 625A is set to a predefined value that identifies the Expiry Time Feedback type.

The Feedback field 620A includes expiry time information associated with the indicated feedback type. In the illustrated example, the Feedback field 620A includes an Expiry Time Feedback field 630A, which includes a TID bitmap field 635A, a Link ID field 640A, and one or more Expiry TSF Time fields 645A. The TID bitmap field 635A identifies the list of one or more TIDs for which expiry time information is provided. The Link ID field 640A identifies a reference link of which the TSF time is used to interpret the expiry time information, such as in the embodiment when the reference link is not the current link (even the Link ID of the current link can be reported as the reference link using the Link ID field). Each Expiry TSF Time field 645A may provide either a relative delay value, such as a time difference between a queue ED and a reference time, or a real expiry TSF time indicating the expiry deadline for the indicated TID.

FIG. 6B illustrates an example format 600B for reporting expiry time information in an ICR using a list-based approach. As shown, a Feedback Per AID TID Info field 605B includes an AID TID Info field 610B, a Block Ack Starting Sequence Control field 615B, and a Feedback field 620B. The Block Ack Starting Sequence Control field 615B includes a Feedback Type field 625B, which indicates that the associated feedback information corresponds to expiry time reporting. In one embodiment, the Feedback Type field 625B is set to a predefined value identifying the Expiry Time Feedback type.

The Feedback field 620B includes expiry time information associated with the indicated feedback type. In the illustrated example, the Feedback field 620B includes an Expiry Time Feedback field 630B, which includes a Count field 650B and one or more Expiry Time Record fields 655B. The Count field 650B indicates a number of expiry time records that follow. Each Expiry Time Record field 655B corresponds to a respective TID and includes a TID field 660B, a Link ID field 665B, and an Expiry TSF Time field 670B. The TID field 660B identifies the TID for which the expiry time information is provided. The Link ID field 665B identifies a reference link of which TSF time is used when interpreting the expiry time information, such as in one embodiment where the reference link is not the current link (even the Link ID of the current link can be reported as the reference link using the Link ID field). The Expiry TSF Time field 670B may include either a relative delay value, such as a time difference between a queue ED and a reference time, or an absolute expiry TSF time indicating an expiry deadline for the indicated TID. The Link ID field 665B is optional and can be omitted when the current link is used as the reference link. The Link ID field 665B may be included if the current link is used as the reference link, and the Link ID field is set to the link identifier of the current link.

In some embodiments, expiry time (or delay feedback) information is transmitted out-of-band, separate from data transmission, using management or action frames, such as a UHR Link Reconfiguration Notify frame or another action frame. A new Type field value can be defined for the UHR Link Reconfiguration Notify frame for reporting delay feedback information. In the UHR Link Reconfiguration Notify frame (with the new Type value), a new element/subelement/field is included that provides expiry time (or delay feedback) information for one or more TIDs as described in the embodiments above when this information is provided in-band or in the control frames.

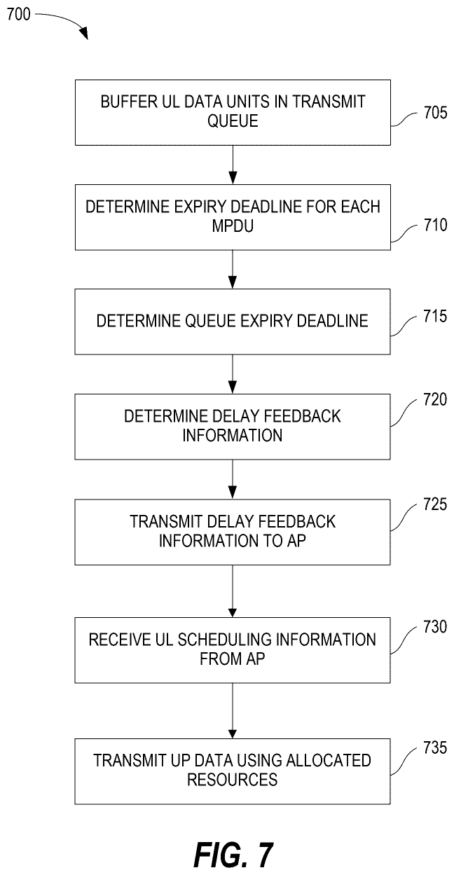

FIG. 7 depicts an example method 700 performed by a STA for determining and reporting real-time delay feedback to an AP for triggered UL scheduling. The STA may correspond to a single-link STA, a multi-link STA, or another type of client device operating within a wireless network. The AP may correspond to a wireless AP, a multi-link AP, a mobile AP, or another network device configured to coordinate UL transmissions from one or more STAs.

At block 705, the STA buffers UL data units in a transmit (Tx) queue (e.g., 215 in FIG. 2). The Tx queue may be organized on a per-TID basis, a per-AC basis, a per-SCS ID basis, or using a mapping where multiple TIDs are associated with one or more queues. The buffered UL data units may include MPDUs (e.g., 210 in FIG. 2), each comprising one or more MSDUs (e.g., 205 in FIG. 2) or one or more A-MSDUs.

At block 710, the STA determines an ED for each MPDU buffered in the Tx queue. For each MPDU, the STA determines the expiry time for MSDUs and/or A-MSDUs encapsulated in the MPDU and sets the ED of the MPDU equal to the earliest expiry time among the encapsulated MSDUs or A-MSDUs.

At block 715, the STA determines a queue ED for use in delay feedback reporting. The queue ED may be selected based on an earliest ED among multiple MPDUs buffered in the Tx queue or based on an ED of a HoL MPDU in the Tx queue. In some embodiments, when multiple MPDUs are aggregated in an A-MPDU, the queue ED may be determined based on EDs of MPDUs included in the A-MPDU (e.g., the earliest ED among the multiple MPDUs aggregated in an A-MPDU can be used for queue ED).

At block 720, the STA determines delay feedback information based on the queue ED. In some embodiments, the delay feedback information comprises a relative delay value, such as a time difference between the queue ED and a reference time of a reference link. For example, the relative delay value may be determined as the earliest ED among queued MPDUs minus a current TSF time, or as an ED of a HoL MPDU minus the current TSF time. In some embodiments, instead of reporting an exact time difference, the relative value may be selected from a predefined set of delay value ranges (e.g., <5 msec, 10-20 msec, 20-30 msec, 30-50 msec, 50-100 msec, or >100 msec), such that the reported value corresponds to a delay bucket representing delay urgency. In other embodiments, the delay feedback information comprises a real or absolute ED, such as a TSF-based expiry time corresponding to the earliest ED among queue MPDUs or the ED of the HoL MPDU.

At block 725, the STA transmits the delay feedback information to the AP, for example, using in-band signaling within a data frame (e.g., via a new A-Control field or an extended EBSR Control field) or using out-of-band signaling via a control frame (e.g., an ICF or an ICR frame) or using a management or action frame (e.g., a UHR Link Reconfiguration Notify frame).

At block 730, the STA receives UL scheduling information from the AP based on in part on the transmitted delay feedback information, including receipt of a TF (e.g., 315 in FIG. 3A or 335 in FIG. 3B) that allocates UL resources (e.g., RUs) in a current service interval or in a subsequent service interval (as depicted in FIGS. 3A and 3B).

At block 735, the STA transmits UL data (e.g., 320 in FIG. 3A or 340 in FIG. 3B) using the allocated UL resources in response to the received TF.

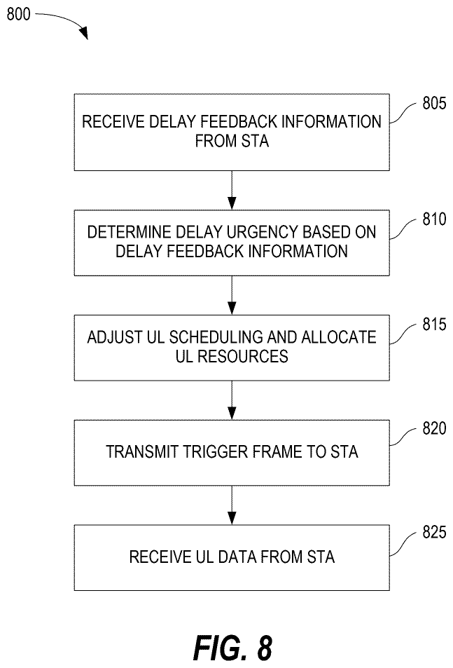

FIG. 8 depicts an example method 800 performed by an AP for adjusting triggered UL scheduling based on real-time delay feedback received from a STA. The STA may correspond to a single-link STA, a multi-link STA, or another type of client device operating within a wireless network. The AP may correspond to a wireless AP, a multi-link AP, a mobile AP, or another network device configured to coordinate UL transmissions from one or more STAs.

At block 805, the AP receives delay feedback information from an associated STA. The delay feedback information may be transmitted in-band within UL QoS data frames or UL QoS null frames, such as via a new A-Control field or an extended EBSR field, or out-of-band using one or more control frames (e.g., an ICF or an ICR frame) or a management/action frame (such as a UHR Link Reconfiguration Notify frame). The delay feedback information may be associated with one or more TIDs or ACs or SCS streams and may be received during a triggered UL TXOP exchange or any other time from a STA.

At block 810, the AP determines delay urgency based on the received delay feedback information. The AP interprets whether the delay feedback information represents a relative delay value or a real expiry TSF deadline. The AP further identifies a reference link associated with the delay feedback information and determines delay urgency for one or more TIDs, including whether an ED is imminent or has already passed.

At block 815, the AP adjusts UL scheduling and allocates UL resources based on the determined delay urgency. In some embodiments, the AP adjusts UL scheduling within a current service interval (as depicted in FIG. 3A), such as by allocating additional or larger RUs. In other embodiments, the AP adjusts UL scheduling in a subsequent service interval (as depicted in FIG. 3B), such as by increasing RUs in a future triggered UL transmission. Resource allocation may include determining RU size, number of RUs, modulation and coding parameters, or other UL transmission parameters.

At block 820, the AP transmits a TF (e.g., 315 in FIG. 3A or 335 in FIG. 3B) to the STA, indicating the allocated UL resources and scheduling parameters for the adjusted UL transmission.

At block 825, the AP receives UL data from the STA transmitted using the allocated UL resources in response to the TF.

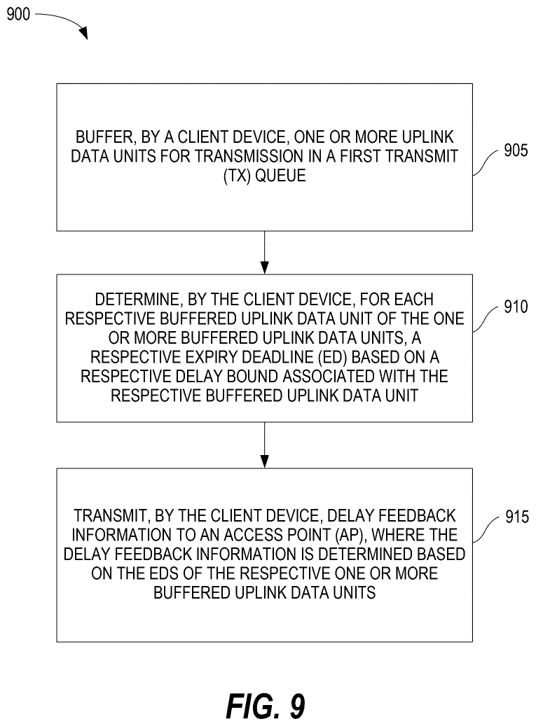

FIG. 9 is a block diagram depicting a delay feedback reporting method 900, according to some embodiments of the present disclosure.

At block 905, a client device buffers one or more uplink data units (e.g., MPDUs 210 in FIG. 2) for transmission in a first transmit (Tx) queue (e.g., 215 in FIG. 2).

In some embodiments, the uplink data unit comprises a media access control (MAC) protocol data unit (MPDU) (e.g., MPDUs 210 in FIG. 2).

At block 910, the client device determines, for each respective buffered uplink data unit of the one or more buffered uplink data units, a respective expiry deadline (ED) based on a respective delay bound associated with the respective buffered uplink data unit.

In some embodiments, the operation of determining the ED for the MPDU comprises determining an expiry time for each MAC service data unit (MSDU) (e.g., MSDUs 205 in FIG. 2) encapsulated in the MPDU, and setting the ED of the MPDU equal to an earliest expiry time among the MSDUs encapsulated in the MPDU.

At block 915, the client device transmits delay feedback information to an access point (AP), where the delay feedback information is determined based on the respective EDs of the one or more buffered uplink data units.

In some embodiments, the delay feedback information comprises a relative delay value representing a time difference between a queue ED and a current time reference.

In some embodiments, the queue ED is determined based on an earliest ED among the EDs of the one or more uplink data units buffered in the first Tx queue.

In some embodiments, the queue ED is determined based on an ED of a head-of-line (HoL) uplink data unit in the first Tx queue, the Hol uplink data unit (e.g., MPDU 1 (210-1) in FIG. 2) corresponding to a buffered uplink data unit positioned first for transmission in the first Tx queue.

In some embodiments, the delay feedback information comprises a queue ED determined based on an earliest ED among the EDs of the one or more uplink data units buffered in the first Tx queue.

In some embodiments, the relative delay value is selected from a lookup table comprising a plurality of defined delay value ranges, each delay value range corresponding to a respective delay urgency level.

In some embodiments, the delay feedback information comprises a queue ED based on an ED of a head-of-line (HoL) uplink data unit in the first Tx queue, the HoL uplink data unit (e.g., MPDU 1 (210-1) in FIG. 2) corresponding to a buffered uplink data unit positioned first for transmission in the first Tx queue.

In some embodiments, the AP, upon receiving the delay feedback information from the client device, adjusts triggered uplink scheduling for the client device based on the delay feedback information.

In some embodiments, the AP adjusts the triggered uplink scheduling, comprising allocating one or more resource units (RUs) to the client device within a same service interval (e.g., Service Interval 2 as depicted in FIG. 3A) during which the delay feedback information is received.

In some embodiments, the AP adjusts the triggered uplink scheduling, comprising allocating one or more resource units (RUs) to the client device within a next service interval (e.g., Service Interval 3 as depicted in FIG. 3B) following receipt of the delay feedback information.

In some embodiments, the operation of transmitting the delay feedback information comprises transmitting the delay feedback information in an A-Control field of a quality-of-service (QoS) data frame or a QoS null frame.

In some embodiments, the A-Control field comprises an extended enhanced buffer status report (EBSR) control field.

In some embodiments, the A-Control field comprises at least one of a traffic identifier (TID) field (e.g., 405A in FIG. 4A) identifying traffic associated with the delay feedback information, a link identifier (Link ID) field (e.g., 410A in FIG. 4A) identifying a reference link that is used as a time reference for the delay feedback information, or a field (e.g., 415A in FIG. 4A) indicating the delay feedback information.

In some embodiments, the operation of transmitting the delay feedback information comprises transmitting the delay feedback information in a control frame.

In some embodiments, the control frame comprises an initial control frame (ICF) or an initial control response (ICR).

In some embodiments, the one or more uplink data units are associated with a same traffic identifier (TID), access category (AC), or stream classification service identifier (SCS ID).

In some embodiments, the client device further buffers one or more uplink data units for transmission in a second Tx queue, the second Tx queue being associated with a traffic identifier (TID), an access category (AC), or a stream classification service identifier (SCS ID) different from the first Tx queue, determines, for each respective buffered uplink data unit of the one or more buffered uplink data units in the second Tx queue, a respective ED based on a respective delay bound associated with the respective buffered uplink data unit, and transmits delay feedback information to the AP or a second AP for the second queue, where the delay feedback information is determined based on the respective EDs of the one or more buffered uplink data units in the second Tx queue.

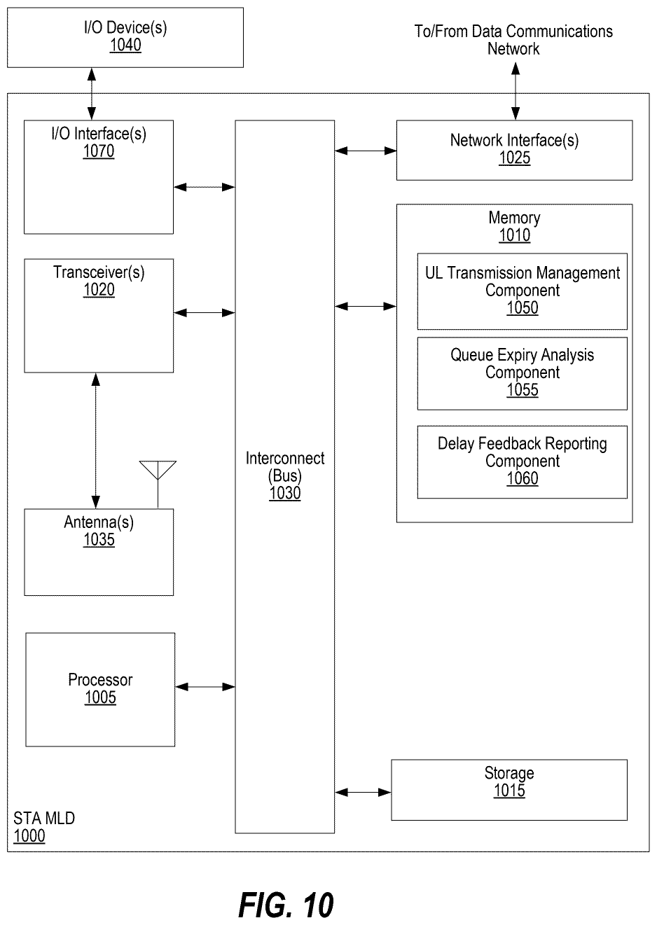

FIG. 10 depicts an example STA MLD 1000 configured to perform various aspects of the present disclosure, according to some embodiments of the present disclosure.

As illustrated, the STA MLD 1000 includes a processor 1005, memory 1010, storage 1015, one or more transceivers 1020, one or more I/O interfaces 1090, and one or more network interfaces 1025. In some embodiments, I/O devices 1040 are connected via the I/O interface(s) 1080. Further, via the network interface 1025, the STA MLD 1000 can be communicatively coupled with one or more other devices and components (e.g., via a network, which may include the Internet, local network(s), and the like). Each of the components is communicatively coupled by one or more buses 1030. In some embodiments, one or more antennas 1035 may be coupled to the transceivers 1020 for transmitting and receiving wireless signals.

The processor 1005 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1005 processes information received through the transceivers 1020, I/O interfaces 1090, and the network interfaces 1025. The processor 1005 retrieves and executes programming instructions stored in memory 1010, as well as stores and retrieves application data residing in storage 1015.

The storage 1015 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1015 may store a variety of data for the efficient functioning of the system.

The memory 1010 may include random access memory (RAM) and read-only memory (ROM). The memory 1010 may store processor-executable software code containing instructions that, when executed by the processor 1005, enable the ST A MLD 1000 to perform various functions described herein for wireless communication.

As depicted, the memory 1010 includes an UL transmission management component 1050, a queue expiry analysis component 1055, and a delay feedback reporting component 1060.

In one embodiment, the UL transmission management component 1050 is configured to manage buffering and transmission of UL data units at the STA. The UL transmission management component 1050 maintains one or more Tx queues for UL data units, where the Tx queues may be organized on a per-TID basis, a per-AC basis, or using a mapping between multiple TIDs and one or more queues. The UL transmission management component 1050 further manages transmission of UL data in response to TFs received from an AP, including selection of UL data units for transmission using allocated UL resources.

In one embodiment, the queue expiry analysis component 1055 is configured to determine expiry-related timing information for UL data buffered in the Tx queues. The queue expiry analysis component 1055 determines expiry times for MSDUs/A-MSDUs based on associated delay bounds, determines an ED for each MPDU/A-MPDU based on expiry times of encapsulated MSDUs/A-MSDUs, and determines a queue ED for delay feedback reporting. The queue ED may be determined based on an earliest ED among MPDUs buffered in a Tx queue or based on an ED of a HoL MPDU in the Tx queue.

In one embodiment, the delay feedback reporting component 1060 is configured to generate and transmit delay feedback information to an AP based on the queue ED. The delay feedback reporting component 1060 determines delay feedback information (e.g., either a relative delay value or an expiry TSF time) and then encodes the delay information and transmits it to an associated AP using in-band signaling within data frames or out-of-band signaling using control frames.

Although depicted as a discrete component for conceptual clarity, in some embodiments, the operations of the depicted components (and others not illustrated) may be combined or distributed across any number of components. Further, although depicted as software residing in memory 1010, in some embodiments, the operations of the depicted components (and others not illustrated) may be implemented using hardware, software, or a combination of hardware and software.

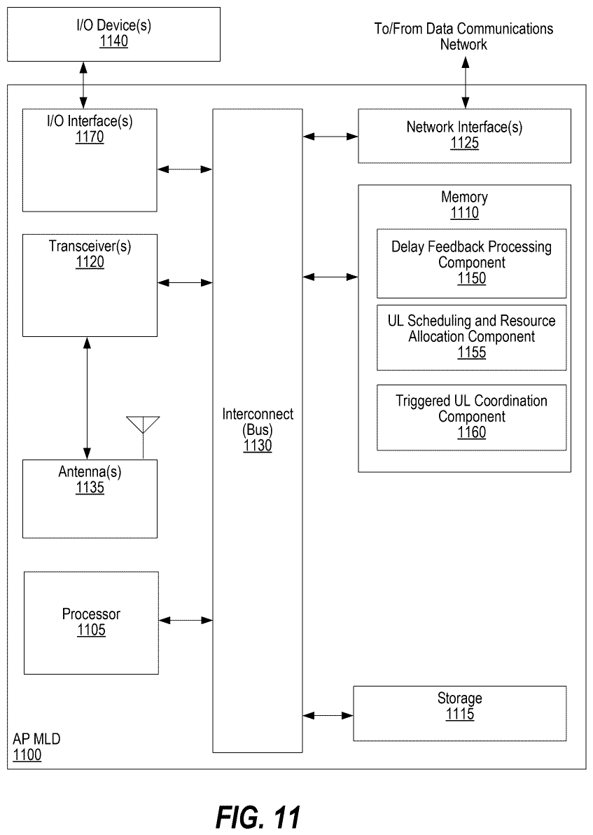

FIG. 11 depicts an example AP MLD 1100 configured to perform various aspects of the present disclosure, according to some embodiments of the present disclosure.

As illustrated, the AP MLD 1100 includes a processor 1105, memory 1110, storage 1115, one or more transceivers 1120, one or more I/O interfaces 1190, and one or more network interfaces 1125. In some embodiments, I/O devices 1140 are connected via the I/O interface(s) 1180. Further, via the network interface 1125, the AP MLD 1100 can be communicatively coupled with one or more other devices and components (e.g., via a network, which may include the Internet, local network(s), and the like). Each of the components is communicatively coupled by one or more buses 1130. In some embodiments, one or more antennas 1135 may be coupled to the transceivers 1120 for transmitting and receiving wireless signals.

The processor 1105 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1105 processes information received through the transceivers 1120, I/O interfaces 1190, and the network interfaces 1125. The processor 1105 retrieves and executes programming instructions stored in memory 1110, as well as stores and retrieves application data residing in storage 1115.

The storage 1115 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1115 may store a variety of data for the efficient functioning of the system.

The memory 1110 may include random access memory (RAM) and read-only memory (ROM). The memory 1110 may store processor-executable software code containing instructions that, when executed by the processor 1105, enable the AP MLD 1100 to perform various functions described herein for wireless communication.

As depicted, the memory 1110 includes a delay feedback processing component 1150, an UL scheduling and resource allocation component 1155, and a triggered UL coordination component 1160.

In one embodiment, the delay feedback processing component 1150 is configured to receive and interpret delay feedback information transmitted by one or more STAs. The delay feedback processing component 1150 parses delay feedback information transmitted in-band (e.g., within UL data units) or out-of-band (e.g., within control frames), identifies one or more TIDs or Acs to which the delay feedback applies, and determines whether the delay feedback information represents a relative delay value or an expiry TSF time. The delay feedback processing component 1150 further interprets reference timing information, including a TSF time and an associated reference link when a Link ID is provided, and determines delay urgency for UL data buffered at the reporting STA.

In one embodiment, the UL scheduling and resource allocation component 1155 is configured to adjust triggered UL scheduling based on delay urgency determined from the delay feedback information. The UL scheduling and resource allocation component 1155 determines whether to modify UL scheduling within a current service interval (e.g., TXOP) or in a subsequent service interval, selects UL resource allocation parameters based on the determined delay urgency, and allocates UL resources accordingly. The allocated UL resources may include one or more RUs, adjusted RU sizes, or other UL transmission parameters to prioritize the transmission of latency-sensitive UL traffic.

In one embodiment, the triggered UL coordination component 1160 is configured to coordinate execution of triggered UL transmissions based on the allocated UL resources. More specifically, the triggered UL coordination component 1160 generates and transmits TFs indicating the allocated UL resources, coordinates reception of UL data transmitted by one or more STAs in response to the TFs, and manages completion of triggered UL TXOPs, including reception of BAs. The triggered UL coordination component 1160 may further provide UL transmission results to the UL scheduling and resource allocation component 1155 for subsequent scheduling decisions and adjustments.

Although depicted as a discrete component for conceptual clarity, in some embodiments, the operations of the depicted components (and others not illustrated) may be combined or distributed across any number of components. Further, although depicted as software residing in memory 1110, in some embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
buffering, by a client device, one or more uplink data units for transmission in a first transmit (Tx) queue;
determining, by the client device, for each respective buffered uplink data unit of the one or more buffered uplink data units, a respective expiry deadline (ED) based on a respective delay bound associated with the respective buffered uplink data unit; and
transmitting, by the client device, delay feedback information to an access point (AP), wherein the delay feedback information is determined based on the respective EDs of the one or more buffered uplink data units.

2. The method of claim 1, wherein the uplink data unit comprises a media access control (MAC) protocol data unit (MPDU).

3. The method of claim 2, wherein determining the ED for the MPDU comprises:
determining an expiry time for each respective MAC service data unit (MSDU) encapsulated in the MPDU, and
setting the ED of the MPDU equal to an earliest expiry time among the MSDUs encapsulated in the MPDU.

4. The method of claim 1, wherein the delay feedback information comprises a relative delay value representing a time difference between a queue ED and a current time reference.

5. The method of claim 4, wherein the queue ED is determined based on an earliest ED among the EDs of the one or more uplink data units buffered in the first Tx queue.

6. The method of claim 4, wherein the queue ED is determined based on an ED of a head-of-line (HoL) uplink data unit in the first Tx queue, the Hol uplink data unit corresponding to a buffered uplink data unit positioned first for transmission in the first Tx queue.

7. The method of claim 1, wherein the delay feedback information comprises a queue ED determined based on an earliest ED among the EDs of the one or more uplink data units buffered in the first Tx queue.

8. The method of claim 4, wherein the relative delay value is selected from a lookup table comprising a plurality of defined delay value ranges, each delay value range corresponding to a respective delay urgency level.

9. The method of claim 1, wherein the delay feedback information comprises a queue ED based on an ED of a head-of-line (HoL) uplink data unit in the first Tx queue, the Hol uplink data unit corresponding to a buffered uplink data unit positioned first for transmission in the first Tx queue.

10. The method of claim 1, wherein the AP, upon receiving the delay feedback information from the client device, adjusts triggered uplink scheduling for the client device based on the delay feedback information.

11. The method of claim 10, wherein the AP adjusts the triggered uplink scheduling, comprising:
allocating one or more resource units (RUs) to the client device within a same service interval during which the delay feedback information is received.

12. The method of claim 10, wherein the AP adjusts the triggered uplink scheduling, comprising:
allocating one or more resource units (RUs) to the client device within a next service interval following receipt of the delay feedback information.

13. The method of claim 1, wherein transmitting the delay feedback information comprises transmitting the delay feedback information in an A-Control field of a quality-of-service (QoS) data frame or a QoS null frame.

14. The method of claim 13, wherein the A-Control field comprises an extended enhanced buffer status report (EBSR) control field.

15. The method of claim 13, wherein the A-Control field comprises at least one of:
a traffic identifier (TID) field identifying traffic associated with the delay feedback information,
a link identifier (Link ID) field identifying a reference link that is used as a time reference for the delay feedback information, or
a field indicating the delay feedback information.

16. The method of claim 1, wherein transmitting the delay feedback information comprises transmitting the delay feedback information in a control frame.

17. The method of claim 16, wherein the control frame comprises an initial control frame (ICF) or an initial control response (ICR) frame.

18. The method of claim 1, wherein the one or more uplink data units are associated with a same traffic identifier (TID), access category (AC), or stream classification service identifier (SCS ID).

19. The method of claim 1, wherein transmitting the delay feedback information comprises transmitting the delay feedback information in a management frame.

20. The method of claim 1, further comprising:
buffering, by the client device, one or more uplink data units for transmission in a second Tx queue, the second Tx queue being associated with a traffic identifier (TID), an access category (AC), or a stream classification service identifier (SCS ID) different from the first Tx queue;
determining, by the client device, for each respective buffered uplink data unit of the one or more buffered uplink data units in the second Tx queue, a respective ED based on a respective delay bound associated with the respective buffered uplink data unit; and
transmitting, by the client device, delay feedback information to the AP or a second AP for the second Tx queue, wherein the delay feedback information is determined based on the respective EDs of the one or more buffered uplink data units in the second Tx queue.

21. A system of a client device, comprising:
one or more computer processors; and
one or more memories collectively containing one or more programs, which, when executed by the one or more computer processors, perform an operation, the operation comprising:
buffering, by the client device, one or more uplink data units for transmission in a first transmit (Tx) queue;
determining, by the client device, for each respective buffered uplink data unit of the one or more buffered uplink data units, a respective expiry deadline (ED) based on a respective delay bound associated with the respective buffered uplink data unit; and
transmitting, by the client device, delay feedback information to an access point (AP), wherein the delay feedback information is determined based on the respective EDs of the one or more buffered uplink data units.

22. A computer program product comprising one or more computer-readable storage media collectively containing computer-readable program code that, when executed by operation of one or more computer processors, performs an operation comprising:
buffering, by a client device, one or more uplink data units for transmission in a first transmit (Tx) queue;
determining, by the client device, for each respective buffered uplink data unit of the one or more buffered uplink data units, a respective expiry deadline (ED) based on a respective delay bound associated with the respective buffered uplink data unit; and
transmitting, by the client device, delay feedback information to an access point (AP), wherein the delay feedback information is determined based on the EDs of the respective one or more buffered uplink data units.
